(19) United States
(12) Patent Application Publication
(10) Pub. No.: US 2003/0115082 A1
(43) Pub. Date: Jun. 19, 2003

(54) Mobile productivity tool for healthcare providers

(76) Inventors: Vince C. Jacobson, Eden Prairie, MN (US); Chad Robran, Corcoran, MN (US); Thomas J. Huot, Loretto, MN (US)

Correspondence Address: Oppenheimer Wolff & Donnelly LLP, Suite 3300, 45 South Seventh Street, Minneapolis, MN, 55402-1609, US

(21) Appl. No.: 10/226,293

(22) Filed: Aug. 22, 2002

Related U.S. Application Data
(60) Provisional application No. 60/314,992, filed on Aug. 24, 2001.

(51) Int. Cl. G06F 17/00; G06F 7/00; G06F 17/60

(52) U.S. Cl. 705/2

(57) ABSTRACT

A productivity tool (for a medical clinic, veterinary clinic, or even other non-medical environments) includes at least four primary aspects: (1) embedding photographic or other records in patient records in an encounter-centric manner such that the records are associated to the applicable encounter within a particular visit; (2) using an array of indices for rapid access to a record within a large body of compressed data without requiring decompression of the entire data; (3) providing efficient and accurate prescription writing via a customizable database by which a physician sets up common prescription scenarios (such as the dosage, the number of refills, the frequency, etc.) and these scenarios populate a prescription screen; and (4) synchronizing a repository across multiple mobile computing devices using an administered identifier space to track identifier ranges reserved to the mobile computing devices.

### CROSS-REFERENCE TO RELATED APPLICATION

This application claims the benefit of U.S. Provisional Application No. 60/314,992 filed on Aug. 24, 2002, entitled “Mobile Productivity Tool for Healthcare Providers,” the contents of which are incorporated herein by reference.

### COMPUTER PROGRAM LISTING APPENDIX

The attached computer program listing appendix CD-R includes source code and data files that implement one embodiment of the present invention when they are loaded on a personal digital assistant (“PDA”) running the PALM brand operating system. The files in the attached computer program listing appendix are listed in Appendix A of this document, and are incorporated herein by reference.

### BACKGROUND OF THE INVENTION

The present invention is a productivity tool for healthcare professionals. The invention has a number of aspects that makes it a particularly good solution to the various problems found in other tools in the prior art, namely: (A) how to store results from diagnostic testing (such as x-rays and digital photographs) in a manner allowing observation of a patient over time; (B) how to maximize memory conservation when working with large data files; (C) how to facilitate the writing of pharmaceutical prescriptions; and (D) how to synchronize a group of productivity tools carried by various healthcare professionals. Each of these problematic areas will now be addressed in turn.

A. Photographic Information Attachment and Embedding in Medical Patient Records

Many areas of medical practice benefit substantially by use of photography to support patient records. It is possible to support medical records through use of conventional cameras, utilizing a process of developing the photographic film, manually matching the photograph to the patient and pasting it into the patients paper record. This is not very feasible due to the disconnect in time between the time of the photograph and probability of errors in the separate record matching process.

The advent of digital cameras improves the situation in that a single photograph may be taken with no intervening development time, printed immediately, and attached to a patient record, reducing the significance of record matching errors, but it still is cumbersome and unlikely to get regular use.

Furthermore, with the likelihood that paper records will be replaced by electronic records in the near future, printed output is not a suitable medium for capturing the photograph. Digital photography in combination with electronic record keeping would seem to be a natural way to add this capability to a medical practice, however, the need for the clinician to carry additional equipment, the logistics of getting the information added to appropriate patient records present a prohibitive barrier to clinical use. What is needed in the art is a system that would eliminate (or at least reduce) these barriers.

B. Data Compression of Reference Data in Embedded Systems

Embedded computing devices are, by definition, limited in both memory resources and computing resources. This limitation is inherent in most mobile computing devices as a result of both cost and power requirements. Certain applications designed for embedded devices have a requirement to access data from a relatively large reference (that is, a relatively large body of constant data). Data compression is the natural way to minimize reference storage space, however, compression techniques are generally focused upon conserving space required for storage. There is generally an underlying assumption that the compressed volume will be entirely decompressed when it is being used. In a mobile computing device, the space required for temporary storage of the decompressed information is equally important. Most compression algorithms incorporate adaptive coding or other forms of coding requiring processing of preceding data to compute the decompression key for decoding the information of interest. What is needed then, is a system that would support locating and decompressing a desired piece of information embedded in a compressed volume of reference data without needing to decompress any preceding information

C. Writing Pharmaceutical Prescriptions

In a traditional healthcare environment, the physician prescribes a medication by writing the order on a prescription paper. Doctors' illegible penmanship is legendary. In 2000, the Institute of Medicine found that out of the 98,000 estimated annual deaths from medical errors, approximately 7,000 of these deaths resulted from improper medication. As the Institute for Safe Medication Practices points out, in the United States, medication errors cause more deaths each year than do workplace injuries.

Medication errors occur because of the complicated (and often similar) names for drugs. Other problems occur when the improper amount or dosage is prescribed. What is needed in the art is a system that assists the doctor in writing the prescriptions. Such a tool should be easy and quick to use.

D. Synchronizing a Group of Productivity Tools

Mobile computing devices (MCD) are sometimes defined as personal digital assistants (PDA). Most inherent facilities of a PDA's operating systems and applications written to execute on them assume a personal relationship between the information stored/created on the PDA and the corresponding information on the user's desktop computer. The typical approach to data synchronization relies upon creating and exchanging data records, and utilizing unique data identifiers along with stateful interpretation of operations that have been applied to the data.

Data relationships are usually managed using unique record identifiers. A unique record identifier is a value stored as part of the data record that is guaranteed to be unique. In some cases, the value may also be an otherwise meaningful portion of the data, but it is usually a number created when a data record is created expressly for identification purposes. In a database that is only used by only one application, or when the same instance of the database is shared by more than one application, creation of unique identifiers is very straightforward. One only needs to assign a value that does not already exist in that database. For example, if a record is created, and the value ‘100’ is assigned as the unique identifier, the only uniqueness requirement is that no other record exists identified by the value ‘100’.

When data is used in a MCD, and synchronized with a database on a stationary computer, the data in the MCD is actually a copy (complete or partial) of the data in the stationary computer. When a new record is created, a unique identifier may be created within the current instance of the database, however, if new record identifiers are created in both the database and the copy, there is no way to assure that the new records are unique with respect to one another.

In the present art, there are at least six problems in synchronizing a group of MCDs with databases, namely:

Synchronization Problem (1): The unique identifiers of two completely different databases that exist in isolation have nothing in common. That is, if data created in one database is added to another independent database, all relationships based on the unique identifiers are invalid. Example: In FIG. 6, Application 1 using Database 1 may access three records, having the IDs 100, 102, and 110. Application 3 may access three records, having the IDs 101, 102, and 131. Both applications/databases contain a record with the ID 102, but they are entirely different records. If a record from database 3 were added to database 1 with a relationship to identifier 102, the intended relationship (to BBBBB) will actually create an incorrect relationship to ZZZZZ. However, when Application 2 adds a record with a relationship to 102, the correct relationship will be established.

Synchronization Problem (2): An application that is creating unique identifiers can only assure uniqueness within the scope of the data it can “see”. That is, if unique identifiers are simultaneously created for more than one a copy of a database, they may be unique within the copy, but they may not be unique within the aggregate represented by the combined copies. In addition, the MCD paradigm does not anticipate a concept of multiple database users or partial data sets. That is, the paradigm assumes that the MCD contains a mirror image of the same data on a stationary computer, and that there is generally a one-to-one relationship between the MCD and the stationary computer. Example: In FIG. 7, Application 1 using Database 1 may create a new record, assigning the ID 118. Application 2 may also create a new record and assign the ID 118. In both cases, the ID 118 is unique to the extent that the application can determine, however, when the information in the database and the copy are synchronized, both new records will have the same ID.

Synchronization Problem (3): The conventional synchronization logic utilizes identifiers from the stationary database that are uniquely paired with a particular MCD. To maintain this approach with a primary database shared in whole or in part across multiple MCDs, the primary database would have to maintain a set of “remote identifiers” for each MCD, and these “remote identifiers” themselves quickly become non-unique when different subsets of the primary database find their way to a particular MCD. Example: In FIG. 8, Stationary Peer Database contains three records of which two, 100 and 110, have corresponding records in the MCD database. Those records are synchronized using the MCD identifiers 2-12 and 2-13 respectively. The other stationary database record, 102, has no peer in the MCD database, and therefore, there is no MCD identifier (2-??). If the stationary peer database were also synchronized with another MCD, for example Application 3, conventional synchronization logic would require another set (say 3-nn) of identifiers to identify the relationship for its synchronization.

Synchronization Problem (4): The conventional synchronization logic relies heavily upon state information (creation, modification, deletion) to determine how to synchronize the information. This information will yield incorrect results when applied to more than one MCD. Example: In FIG. 8, Stationary Peer Database's record 100 has been modified. When it is synchronized with MCD Database, the synchronization logic will act upon each new or modified record and its state is changed to unmodified after the synchronization. If the stationary peer database were also synchronized with another MCD, for example Application 3, the record would no longer appear modified, and the synchronization logic would ignore the changed record.

Synchronization Problem (5): The conventional synchronization logic cannot discriminate between different views (subset) of the information and information that has been created or deleted. Example: In FIG. 8, Stationary Peer Database's record 102 is not part of the subset resident in MCD database. Conventional synchronization logic provides no means to identify a record as intentionally missing from the synchronized data set.

Synchronization Problem (6): The conventional synchronization logic is dedicated to a specific MCD platform. The predominant MCD devices, Palm OS and Windows CE, each utilize proprietary database storage formats and each provide core synchronization functionality, but that functionality is only suitable for its specific platform. Conventional database and synchronization logic is not well suited for multi-platform support.

Natural Solutions Do Not Alleviate the Problems of Synchronization

The six synchronization problems are not readily fixed. A natural solution to Problem (1) is to create a unique identifier for the database itself. A global management mechanism is required. Since the number of databases is expected to be relatively small, it is typically sufficient to utilize a textual identifier, using a text string having a site component and a functional component e.g., “South Clinic-Pediatrics”.

A potential (but incorrect) solution to the symptoms of (2) would involve creating “temporary” identifiers when adding records to database copies, and replacing them with permanent identifiers when incorporating (synchronizing) information from the copies into the primary database. This approach is actually practical when the primary database is assured to be an active arbiter before the information is transferred to another database copy. It turns out that in a MCD, device to device transfer without an intervening arbiter (e.g. beaming), is a common feature. The solution may be extended to address this “temporary identifier indirection”, however, the complexity of the solution increases with the number of such indirections, and the complexity is not bounded.

In FIG. 9, for example, new records have been created in both “South Clinic-Pediatrics” and the copy used by Application 2, and both assigned identifier 118 to the new record. During synchronization, the collision was identified and a new identifier 144 was created and assigned to the record replacing temporary identifier 118. Prior to synchronization, however, records were beamed from Application 2 to Application 3. Application 3 has created another record, 124, related to the temporary 118. At this point, temporary 118 no longer exists, and when Application 3 synchronizes with “South Clinic-Pediatrics”, the synchronization process will need to recognize that Temp 118 needs to be converted to 144 during synchronization. This is even more complex when Application 3 was synchronized prior to beaming and must deal with containing both record 118 and Temp 118.

The present invention provides unique and useful solutions to all six synchronization problems.

E. Dynamic Usage Focused Adaptation of Databases

Information and collections of information are often stored in databases. In a database, a collection of information is typically defined in a record set, where the record set has a predefined format and contents. The example in Table 1 is a record set definition for a personal information record. In this example, for each individual the database contains a First Name, Last Name, Street, Address, Zip code, and Phone number. The record is identified by a unique ID that can be used to find information about this individual even if the name or any other information in the individual's record is modified. In this case, William Smith at 123 Main in Gary Ind., 12987, with a phone number of 123-456-7890 is identified in record 100.

TABLE 1
Example personal information record set definition
Record Set: Individual

| UniqueID | FirstName | LastName | Street | Address | Zip | Phone |
|---|---|---|---|---|---|---|
| 100 | William | Smith | 123 Main | Gary IN | 12987 | 123-456-7890 |

If there is a need to retain additional information for each individual, for example, FAX, the record set definition can be modified to add a field for FAX, and the applications using the data may then be modified to store and retrieve FAX along with the rest of the individual's information. This may be an acceptable solution for dedicated applications, however, modifying the application each time the information needs change will usually result in excessive software maintenance costs.

A solution is to implement a form layout software algorithm that examines the record set definition and dynamically adapts data entry forms when the record set definition is modified. This approach is more flexible for dedicated applications. If however, the application is a commercial product, the user is usually prevented from modifying the record set definitions.

A mechanism can be used in commercial applications to support end user configuration of information set extensions without associated modification of record set definitions. The mechanism also provides for arbitrary additional feature enrichment support.

The record set extensions are configured by adding entries to a configuration record set. Table 2 is an example of a configuration record set. In that example, the “Individual” record set is to be extended by adding a pseudo-field named “FAX” and one named “Sport”. As an example of enrichment, the acceptable choices for “Sport” are provided as a comma separated list. Note the Record Set Name (“Individual”) is not needed if the configuration extensions are supported for only one record set.

When the application displays or edits Individual data for Individual 100, it first retrieves record 100 and renders it however the application is designed to render the base information. Then, the extensions are obtained from the configuration database—an example SQL query may read, “Select * from Configuration where RecordSet=‘Individual’”—and information from the configuration record set is used to extend the display/edit view. Note that the configuration record set could also include fields informing the application how to display/edit the extended record. In this example, the Choices part of the configuration is a comma separated list and can be used to create a selection list for accelerated editing. This feature is especially important for mobile computing devices, or any system that does not have a full-featured keyboard.

TABLE 2
Record Set Extension Configuration Record Set Definition
Record Set: Configuration

| RecordSet | Extension | Choices |
|---|---|---|
| Individual | FAX | |
| Individual | Sport | Baseball, Football, Basketball, Soccer, Track |

After locating the extensions, the Extension data is located to accompany the extension. Table 3 is an example of a record set containing extension data. An example SQL query may read, “Select Value from Extension where RecordSet=‘Individual’ and Extension=‘FAX’ and Uniqueld=100”. If a Value is found, it is the value of the parameter to be displayed/editied for the extension of interest.

TABLE 3
Record Set Extension Data Record Set Definition
Record Set: Extension

| UniqueID | RecordSet | Extension | Value |
|---|---|---|---|
| 100 | Individual | FAX | 123-456-7777 |
| 100 | Individual | Sport | Basketball |

An application implementing these extensions easily supports user configurable record set extensions. A relatively straightforward software module can be implemented to manage creation and modification of the record set extension configuration by creating and modifying records in the Configuration record set.

### SUMMARY OF THE INVENTION

One aspect of the present invention provides the functionality to capture photographic records during medical encounters in a clinical environment, and to associate those photographic records with the patient medical records quickly, reliably, and in a way that accurately associates the photograph with the specific medical encounter during which the photograph was taken. One embodiment is based on a novel combination of digital image capture, and clinical patient encounter information recording, transfer, and storage. Thus, in one aspect of the present invention, a computer program stored in a computer's memory embeds photos in medical patient records. The computer stores context-centered records corresponding to a series of patients, where there is one patient record and zero or more visit records for each patient. For each visit record there is at least one encounter record. The computer program receives the digital image, associates it to the proper encounter record and stores it in memory. In some embodiments, the encounter and visit record are combined into the same record. In some embodiments, the program is stored on a personal digital assistant. It may communicate the photos will another PDA or computer. The invention may be used in a medical clinic, veterinary clinic, or even other non-medical environment.

Another aspect of the invention provides the functionality for storage of, and rapid access to, large bodies of data on memory limited computing devices without significant overhead in either memory or computing resources. Because mobile devices have limited memory, the large bodies of data are stored in compressed form. An array of indices is used to locate the starting point within the compressed data of the desired information. Using this staring point, a subset of the compressed data is de-compressed, eliminating the need to decompress the entire file.

A third aspect of the present invention enables efficient and accurate prescription writing. From a database of drug information, a subset of drug records can be chosen. From this subset, the physician can customize a common prescription scenario for each, such as the dosage, the number of refills, the frequency, and special instructions. A pull-down list can be used to allow the physician to choose from his or her list of commonly prescribed drugs. The customized information previously stored by the physician is used to populate the computerized prescription screen.

A fourth aspect of the present invention provides for synchronization of a central repository across multiple mobile computing devices. The devices can each be configured to hold all of the central repository, or more usually, to hold only a subset thereof. An administered identifier space is maintained to track the identifier ranges reserved for each of the mobile computing devices. Using this administered space, each device can create new records without risk that the records will be incorrectly synchronized to the central repository.

A fifth aspect of the present invention provides for managing the creation and modification of database record set extensions. Where a primary record set contains pre-defined and static fields that are not intended to be directly accessed by end users, this aspect of the present invention allows for the configuration of record set extensions.

### BRIEF DESCRIPTION OF THE DRAWINGS

FIG. 1 is a block diagram showing data storage and access characteristics.

FIG. 2 is a block diagram illustrating data block markers.

FIG. 3 is a block diagram showing configuration information and indices.

FIG. 4 is a block diagram showing the components for one embodiment of the present invention.

FIG. 5 is a block diagram showing the components for one embodiment of the present invention in which a first MCD communicates with a second MCD.

FIG. 6 is a block diagram showing how databases used by different applications can store a set of shared records as well as unique records.

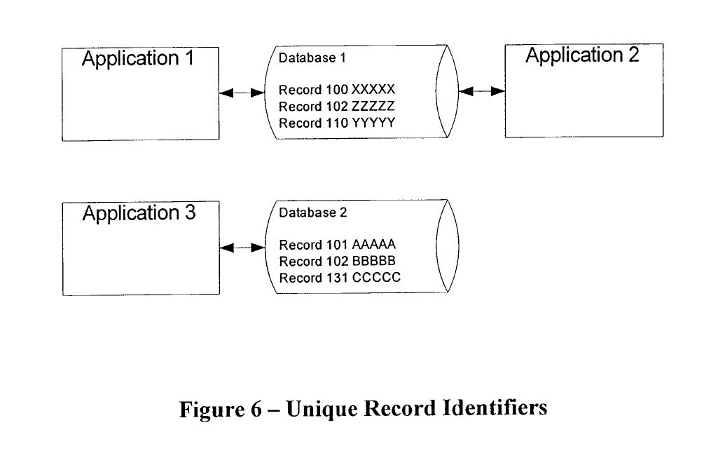

FIG. 7 is a block diagram showing conflicts in the use of record identifier when a record is added or changed by the stationary application and an application on a mobile computing device.

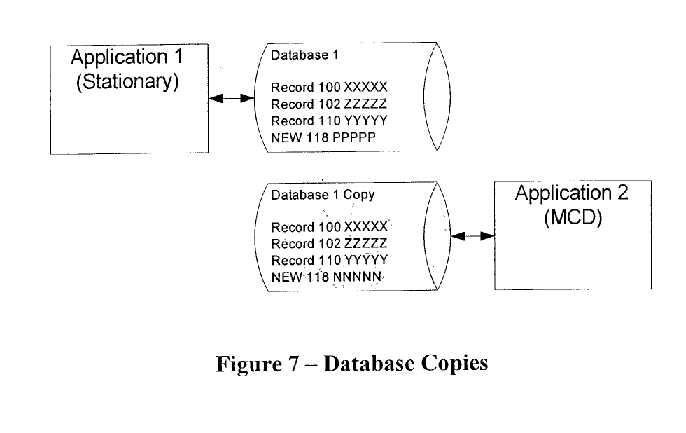

FIG. 8 is a block diagram illustrating the synchronization of a database using state identifiers, such as “unchanged,” “modified,” and “new.”

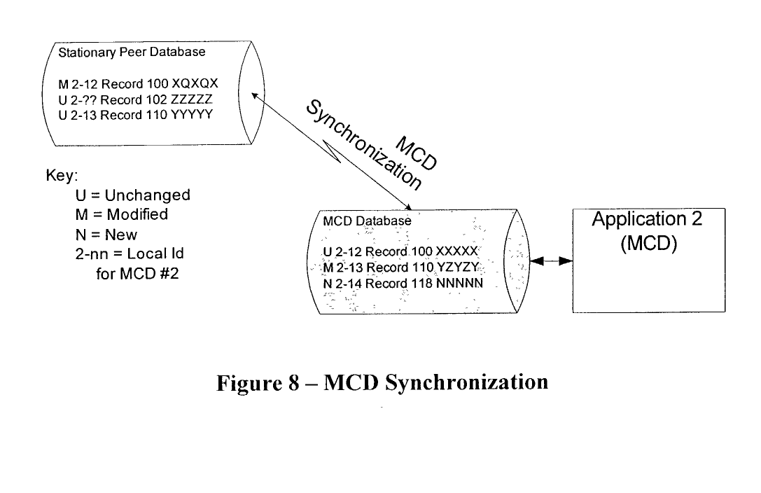

FIG. 9 is a block diagram illustrating the problems resulting from the use of temporary identifiers.

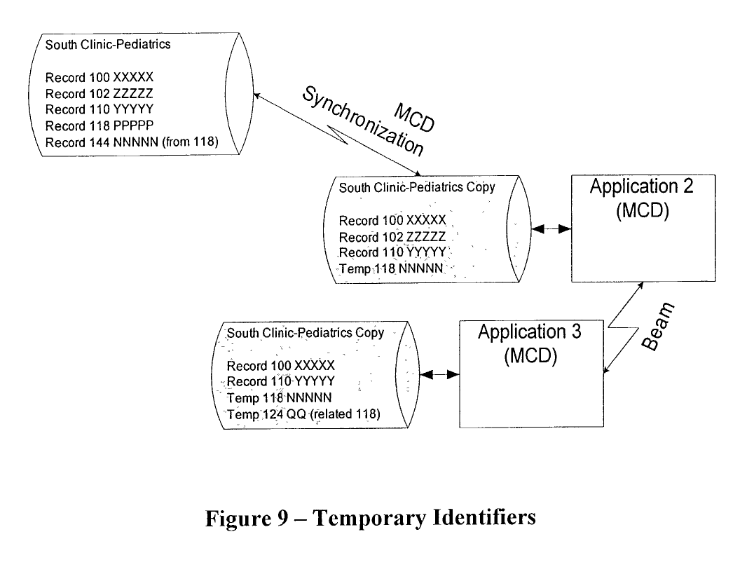

FIG. 10 is a block diagram illustrating the present invention's use of an administered identifier space.

FIG. 11 is a block diagram illustrating two tier synchronization.

FIG. 12 is a screen print of an MCD application that supports a customized listing of common prescriptions.

FIG. 13 a screen print of an MCD application that supports a customized listing of common prescriptions.

FIG. 14 a screen print of setting up a customized prescription scenario.

FIG. 15 is a screen print of an application to write prescriptions for patients.

FIG. 16 is a screen print of an application to write prescriptions for patients, and which supports customized prescription scenarios.

FIG. 17 is a screen print of an application to write prescriptions.

FIG. 18 is a screen print showing a prescription that has been ordered for a patient.

FIG. 19 is a screen print illustrating the fields that would need to be manually entered without the present invention.

### DETAILED DESCRIPTION OF THE INVENTION

The various aspects of the present invention will now be described, as they have been embodied in one embodiment of the invention. The source code and documentation for the code is included in the attached computer program listing appendix. One skilled in the art will recognize that the attached appendix can be used to readily understand, make, and use the inventive aspects of the present invention as part of a mobile productivity tool. While the embodiment described and shown is a tool for healthcare professionals, one skilled in the art understands that these techniques can be easily transferred to other industries.

A. Photographic Information Attachment and Embedding in Medical Patient Records

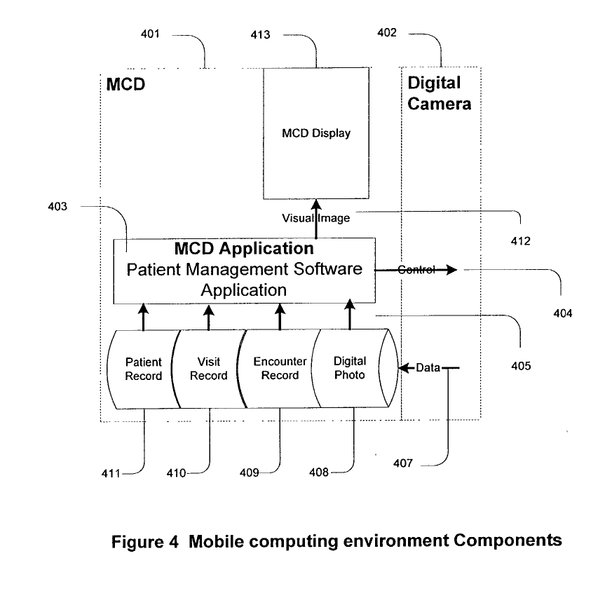

The invention relies upon usage of digital photography capable mobile computing devices (“MCD”). Referring to FIG. 4, such an MCD 401 is a member of a class of computers intended for use in a mobile, typically hand held, environment, and typically incorporates mechanisms for exchanging applications and data with other computers in either a mobile or a stationary computing environment. Examples of mobile computing devices are the PALM PILOT brand or HANDSPRING brand product that runs the PALM brand operating system and the Compaq brand IPAQ model that runs the Windows CE brand operating system. But the scope of definition of a MCD 401 is not limited to those or any other product, existing now or in the future. The digital photography 402 capability may be an intrinsic capability of the MCD, or result from optional or after-market extensions, that is, 401 and 402 may be separate parts that comprise the MCD 401 or may be the MCD 401 and a connectable accessory 402 that expands the capabilities of the MCD 401. The MCD 401 is also capable of executing a software program 403 designed to capture information observed or obtained in a clinical setting. The software program is also capable of interacting 404 with the digital camera to acquire data 407 representing the image photographed by the digital camera. This combination of operations, equipment, and software cooperate to record a digital photograph, store it 408 within the MCD, and associate it contextually and relationally with the rest of the information during a patient visit within the encounter context (as a patient record 411, a visit record 412, or an encounter record 409) at the time the photograph is taken. The stored information can then be retrieved 405 from its storage location by the MCD application 403 and sent 412 to the MCD display 413 for viewing in context.

Some of the key benefits of this invention include: (1) Since the patient management computer 401 and the digital camera 402 are the same physical device (either intrinsically or functionally), the clinician has only a single device to carry, to achieve this functionality; (2) Since the MCD application 403 manages the clinical data and exerts control over the camera 402, no explicit action is required by the user to establish a correct relationship between the photograph and its context; and (3) Photographs from prior encounters are available immediately for comparison with the patient's current visual appearance. The applications of this invention are important in clinical practice both for monitoring of progressive conditions and for monitoring healing progress.

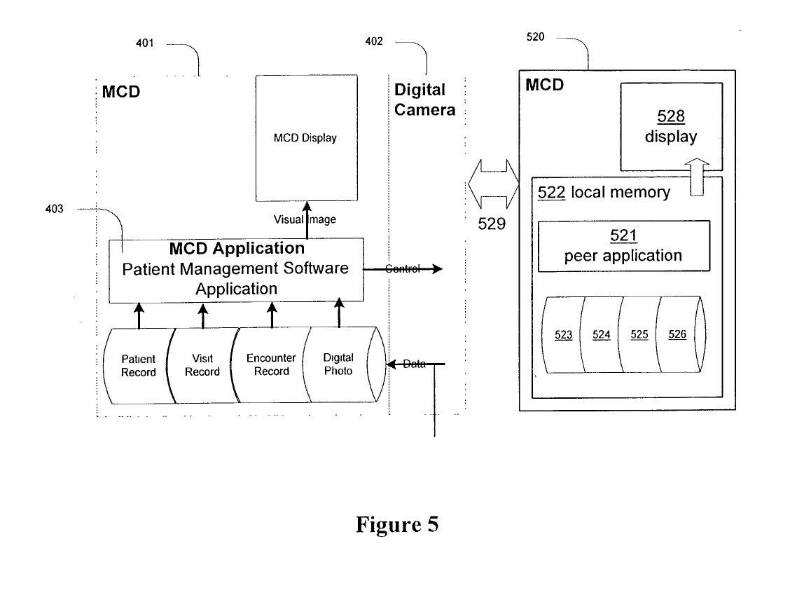

The second embodiment of this invention (illustrated in FIG. 5) is used in an environment where the data used in the MCD 401 is also conveyed 529 to another MCD 520, using a conventional MCD mechanism such as IrDA beaming, to provide the patient encounter information and contextually supported photograph to another clinician for use in a continuation of the patient's earlier encounter. In this case, the information received by the peer application 521 is stored 522 in its local memory 523-526 for its own future use. The stored information can then be retrieved 522 from its storage location by the MCD application 521 and sent 527 to its display 528 for viewing in context. Note that the peer MCD 520 does not require its own digital camera unless it also will be taking photographs.

Another embodiment of this invention is used in an environment where the data used in the MCD is also conveyed to another computer in a stationary environment having a compatible information access structure, such that the MCD collected patient encounter information and contextually supported photograph is available for storage, review, and retrieval using the stationary computer.

One embodiment of this invention is used in an environment where the data used in the MCD is also conveyed to another computer in a stationary environment having a more limited information access structure, such that the MCD collected patient encounter information and is available for storage, review, and retrieval using the stationary computer, and the contextually supported photograph is preserved so that it may be retrieved, transferred to, and reviewed using the MCD.

Another embodiment of this invention is one of the above described embodiments, deployed in a veterinarian clinical setting, or even a non-clinical setting. Examples of this embodiment include application of contextually supported photographs in real estate, automobile appraisal applications, in law enforcement activities, and physical asset inventory applications.

The MCD application 403 and/or peer application 521 can be created using any of several computer programming languages known in the art.

B. Data Compression of Reference Data in Embedded Systems

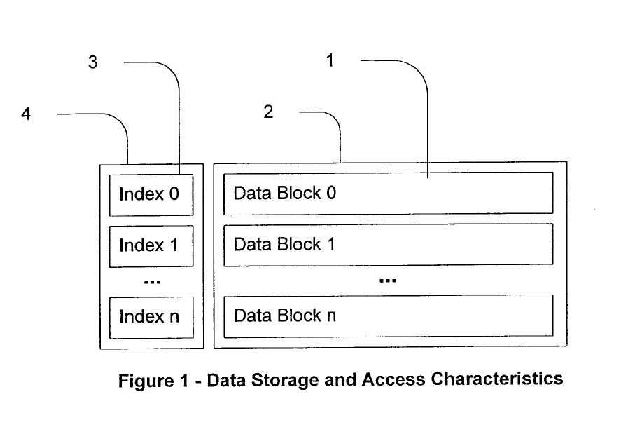

Another important aspect of the invention relates to the compression of the data in the memory. More specifically, this aspect is directed to how to locate and use an arbitrary block within a potentially large body of data efficiently and effectively, minimizing both the required storage space and the access effort. Referring to FIG. 1, a block of data 1 is defined as the information stored in one or more bytes of data storage. The data block has a start, a size, and the contents of those “size” bytes of data storage. If we assume for discussion purposes that all of the data blocks are stored contiguously, the aggregate storage containing all of the data blocks is the data body 2.

The start of a data block 1 is expressed as a location, typically a physical address, or offset from the start of the data body. The size of a data block can be determined in any of a large number of ways. Data with a very uniform size may be expressed as fixed length records. The size of textual data is typically expressed using a “terminator”; a reserved value that is not valid within the text string, such as zero, or the ASCII “tab” or “line feed” characters. Other variable length fields contain a length parameter within the data itself. Complex records such as database records often include a combination of fixed length “fields” and variable length fields. Start and length of data blocks are usually expressed with a resolution of one byte.

In any event, to access a data block, a mechanism must be available to locate the start of the data block and its size. Therefore, such mechanisms must be provided or supported in the process of creating the data block. The mechanism normally used to locate the start of a data block is an index 3, and the aggregation of all indices is called an index set 4. For example, the amount of storage space required for an index that references a 64 kilobyte data block with a resolution of one byte is 16 bits (2 bytes) per index.

As one in the art recognizes, compression is a technique used to increase the amount of information in a given data block size. There are a large number of compression algorithms in common use, and one algorithm may achieve higher compression ratios than another for data having particular characteristics. Virtually all compression algorithms utilize a block of “key data” to describe the “rules” for decompressing data to is original content. Many of the more effective compression algorithms utilize “adaptive coding”, which essentially means that the “key data” is used as a starting point, but the “key data” is modified (adapts) as the data is processed to create “key data” values that are optimized to be most effective for the portion data block where they are applied. While adaptive algorithms produce improved compression, they require that the entire portion of the data body preceding data block of interest be processed to obtain the correct key for the data block of interest.

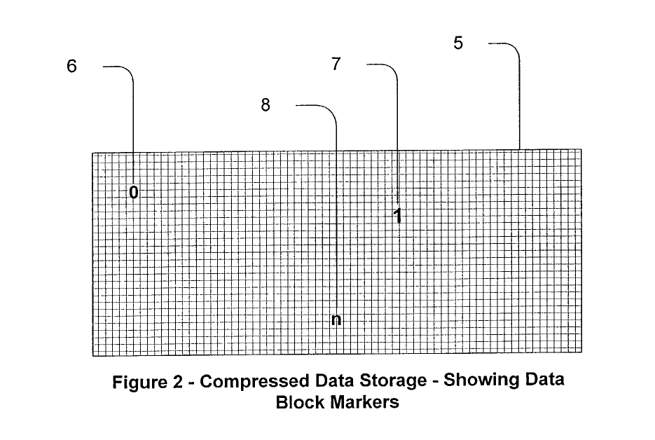

The data body of FIG. 1 may be compressed as shown in FIG. 2. where the data body 5 contains data block starting locations for data blocks 0, 1, . . . n (6, 7, . . . 8). The starting locations are remembered during the compression process (with a one BIT resolution), and those values are used to create indexes for the compressed data body. The restrictions on the compression algorithm are (1) it uses integral bit encoding (one bit is the smallest unit of encoding resolution), and (2) adaptive algorithms should be avoided (the stored key should be valid for all data). Huffman coding is an example of an algorithm that qualifies under these restrictions.

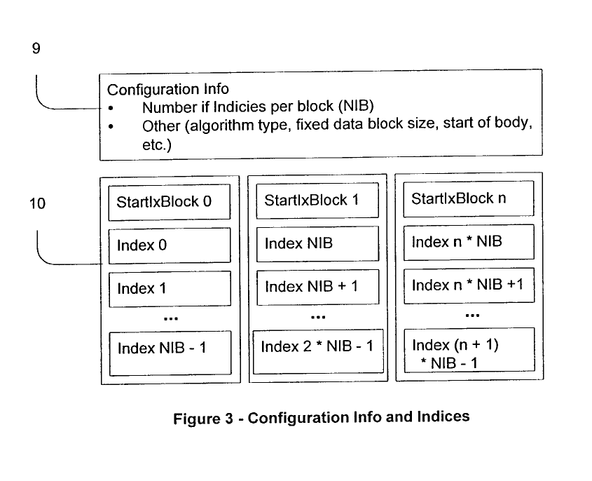

The compressed data index has a one BIT resolution rather than a one BYTE resolution, thus three more encoding bits are required to express the index (19 bits to locate a span of 64 k bytes). Since microprocessors' natural data size is a multiple of 8 bits (BYTES), indices of size modulo 8 bits are used (16 bits in this example). Index blocks 10 (from FIG. 3) are used to provide additional range that cannot be expressed by the index value. Note that the additional index blocks are not required if the size of entire data body is less the 64 k bits (8 k bytes) because the entire scope of the data block can be expressed with a one bit resolution using a 16 bit index value. The blocks are structured with a block start (StartIxBlock) having a BYTE resolution and a fixed number of indices, each representing a BIT resolution offset from the first bit referenced by StartIxBlock. The number of indices per block can be computed during the compression analysis and should be the maximum value in the range 0 . . . 31 that does not result in overflow (overflow occurs when a region larger than than 64 k bits is referenced from a single index block). If, for example, the encoding utilized 16 indices per block, the actual space used for each index would be 17 bits (16 plus 1/16 of the space required by StartIxBlock). A one byte StartIxBlock resolution was used for this example. There is relatively attractive tradeoff available for increased data block sizes by decreasing the StartIxBlock resolution, for example, using a StartIxBlock resolution of 16 bytes will allow a 1 megabyte range to be expressed in a 16 bit parameter. The cost of this tradeoff is a potential reduction of 256 bytes (2048 bits out of 64 k bits) addressable by the BIT resolution indices within any particular index block.

The number of indices per block (NIB) is a constant determined at the time indices are created and is typically stored as part of the data body configuration 10.

To access the data at “DataBlockNbr”, one first computes the starting bit of the data block. For example:

CONSTANT IndexBlockSize = sizeof(StartIxBlock) + NIB * sizeof (Index)
IndexBlockNbr = (DataBlockNbr / NIB)
IndexBlock = DataStructureAtOffset (IndexBlockNbr * IndexBlockSize)
DataBodyFirstByte = IndexBlock.StartIxBlock +

(IndexBlock.Index [DataBlockNbr mod NIB] / 8)

DataBodyFirstBit = (IndexBlock.Index [DataBlockNbr mod NIB] mod 8)

Then one decompresses the body starting at DataBodyFirstByte, DataBodyFirstBit for its defined length, using the compression algorithm that was selected for this data body.

As described earlier, the defined length may be expressed by one of many methods. The method is defined for the data body at the time of compression, and may be “fixed length block”, “terminated by special character”, “length value embedded in data”, or any other method that is appropriate and practical for the characteristics of the data being compressed.

Once the referenced data has been decompressed, it is a memory image of the original data, and it is referenced and utilized in the same way that it would have been if it had never been compressed.

The index, in database terms, is the primary key to the data body. If additional keys to the data (for quick lookups and references) are needed, the most effective approach is to create an external table (that could be packaged in the same binary record) that references the index. The external key approach is well known in the art and is therefore not described herein.

To describe this another way, consider modeling the compressed volume as a database where each index is used to seek to a zero-based motonically incrementing record number. The indices locate the bit within the volume where the record begins. If the intention is to locate records, for example, by drug name, it would be reasonable to order the records by drug name, therefore ordering the indices by drug name. In this case, a prudent designer would organize the records so that the drug name is at the beginning of the record. A “Find” routine could then do an index based binary search in which the comparison routine would decompress characters of the drug name as part of the comparison operation. If there is a need for multiple ordering, the second ordering, for example by generic name, would contain only an ordered list of “record numbers”, and the search operation would be identical except it would include one order of indirection using the “record number” with the first index.

In one embodiment of this aspect of the invention, a computer program uses an array of indices that relate to a compressed data file. When the computer program requires a record from the compressed data file, a record identifier for the record is used to find the starting point of the record from the array of indices. Using the starting point and the record length, the proper subset of the compressed data file is extracted. This subset is then de-compressed to obtain the desired record in uncompressed format.

C. Writing Pharmaceutical Prescriptions

While the idea for writing a pharmaceutical prescriptions using a computer application is not new, prior solutions have merely replaced handwriting requirements with keystrokes. No effort has been made to assist in the types of prescriptions that are commonly prescribed. In addition, no effort has been made to allow each physician-user to customize the way he or she prefers to write prescription orders.

In one embodiment of the present invention, a computer application on a mobile computing device is configured with two functions: (1) the MyRx function that allows customization by each end-user; and (2) the Prescribe Medication function that is used to write a prescription for a particular patient.

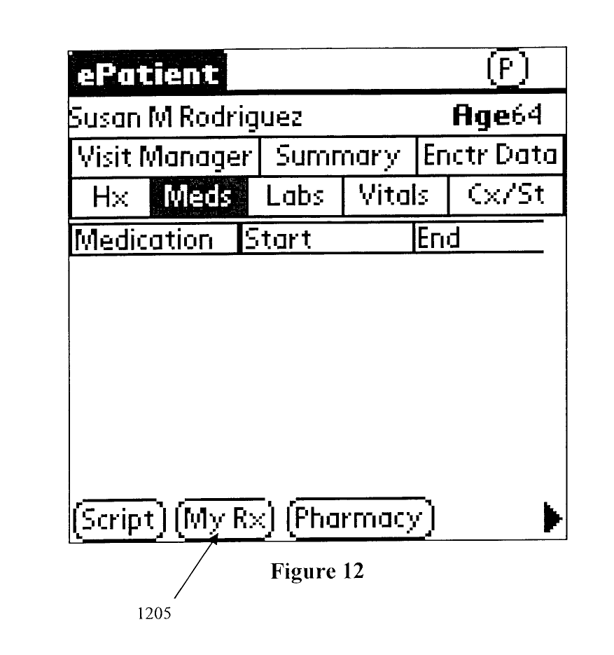

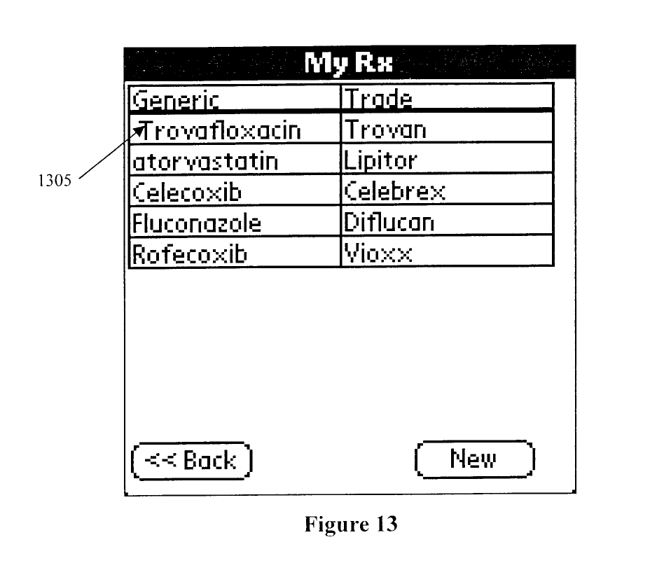

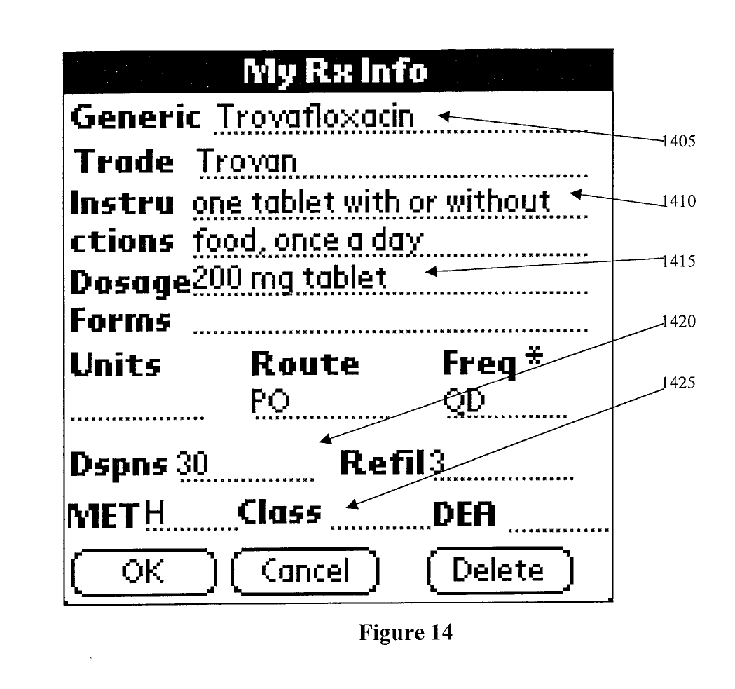

The MyRx function is shown in FIGS. 12 through 14. In FIG. 12, the MyRx function is accessed by pressing the “My Rx” button 1205 on the screen, which brings the physician-user to the screen shown in FIG. 13. Here, a list of drugs set up for the physician is shown 1305. Although the present invention stores information regarding more than one thousand drugs in its central database, the physician may choose to load only a small subset of these drug records into his or her mobile computing device. For example, FIG. 13 shows that five drugs are installed for the user. The drugs are shown with both their generic and trade names for ease of use. By selecting the “new” button, or by selecting one of the already created drug records, the user is shown the “My Rx Info” screen (see FIG. 14). Here, the physician sets up a common prescription scenario for the drug. Again, the generic and trade names for the drugs are shown 1405. Instructions for the medication can be entered or changed 1410. Dosage information 1415, units, route, frequency, number to dispense 1420, number of refills allowed, and classification of drug 1425 can all be set up and maintained.

FIG. 14 shows that the physician-user has set up a customized prescription scenario for Trovan. Under this scenario, 200 milligram tablets are ordered, with 3 refills allowed. Instructions to the patient are “one tablet with or without food, once a day.” All of this information can be first populated by the drug database provided by the present invention and can then be customized by the physician. For example, suppose Trovan is available in 100 mg, 150 mg, and 200 mg tablets. The user can choose which of these three forms is most commonly prescribed and then use this number.

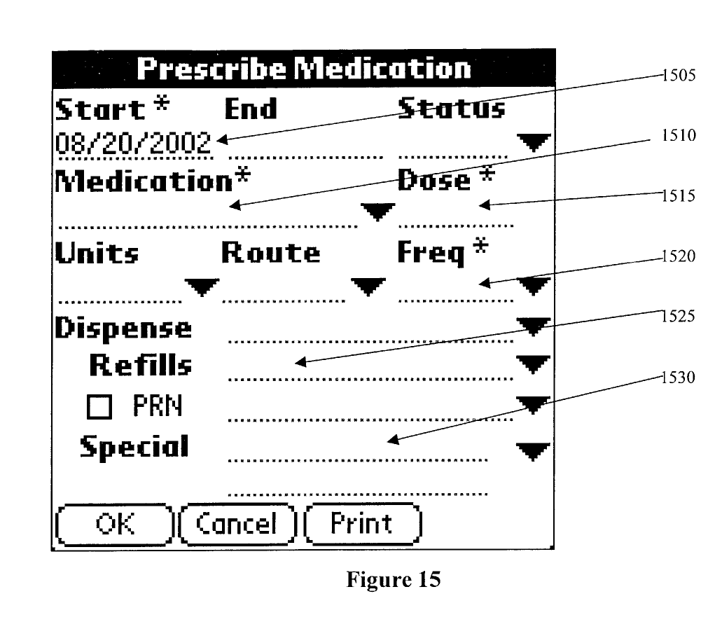

FIGS. 15 through 19 show how the customized scenarios just described are leveraged when writing a prescription. FIG. 5 shows the default “Prescribe Medication” screen, by which the physician places an order for a prescription for a particular patient. Notice that many of the fields correspond to data entered via the MyRX function, namely, dosage 1515, frequency 1520, number to dispense, number of refills 1525, and special instructions.

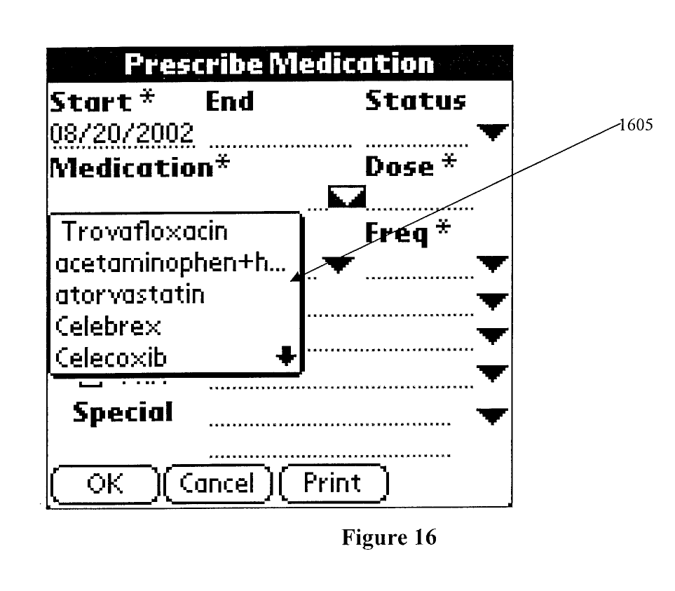

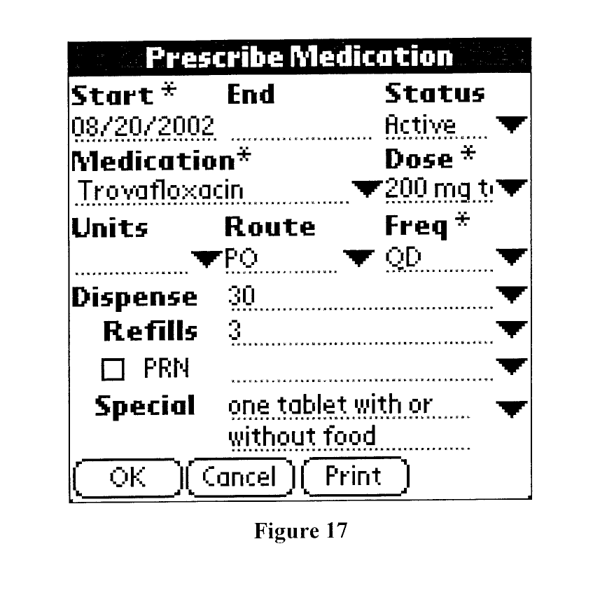

The physician can use the screen shown in FIG. 15 to set up a new prescription from scratch. However, the dropdown menu for the medication name (element 1605 of FIG. 16) can be used to choose one of the supported medications from the drug database. FIG. 17 shows the “Prescribe Medication” screen when the user has selected Trovafloxacin from the dropdown menu. The various fields are automatically populated with the information from the physician's customized MyRx record. Thus, the dosage of 200 mg is selected automatically since that is the one commonly used by that particular physician. However, dropdown menus for the fields allow the physician to modify the prescription to reflect what is desired for the current patent. Thus, the dosage dropdown menus is used if the dosage should be changed to just 100 mgs.

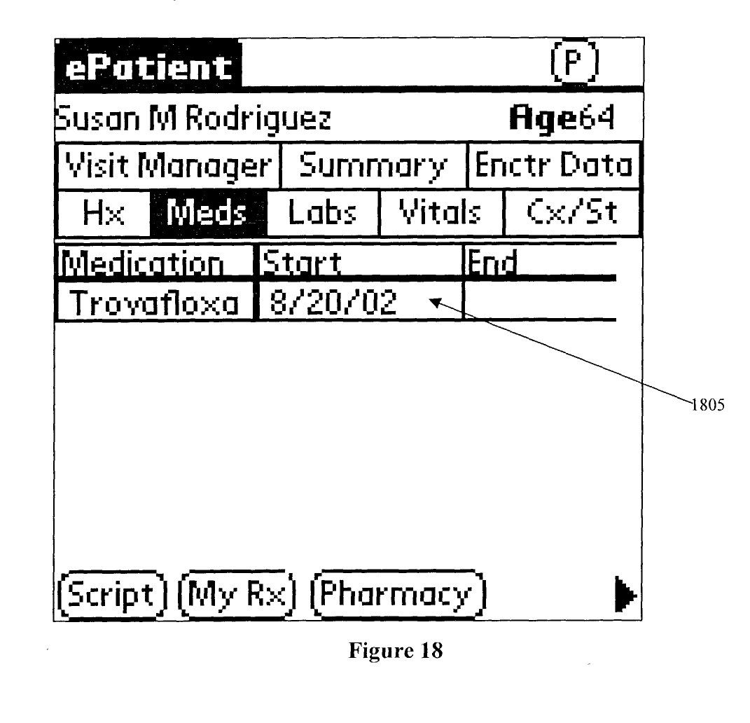

FIG. 18 shows the result after saving a new prescription for a patient. FIG. 18 is the medication list for Susan M. Rodriguez. This list includes one current prescription (for Trovafloxacin).

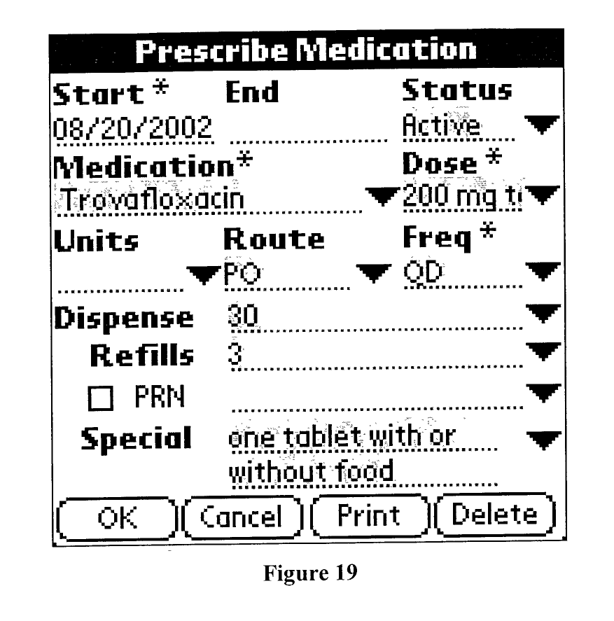

FIG. 19 is an illustrative showing of the amount of data entry that is required of the physician if the present invention's MyRx function is not used. The eight fields highlighted demonstrate that there are eight possible errors that can be made by the physician in writing the prescription shown. By using a pre-defined scenario, the chances of these errors is greatly diminished.

D. Synchronizing a Group of Productivity Tools

The present invention defines a general solution to Synchronization Problems (1) and (2) by allocating a block of globally unique identifiers for local administration by the application instance using each database copy. A unique identifier is constructed from a combination of a unique identifier for the database itself, a unique identifier for the application instance using the database copy and a local unique identifier of the record. The application that maintains the primary database and synchronizes the copies with it also administers the identifier space allocated to each application instance. Both the unique identifier for the database and the identifier space allocation information are maintained in the same database with the data itself to assure that their relationship is intrinsic.

The identifier for the database is a textual identifier having a site component and a functional component e.g., “South Clinic-Pediatrics”, and in this example, the unique record identifiers are stored as long integers (total identifier space of about 4 billion), and the space is arbitrarily divided into two equal parts. One example of the arbitrary partitioning would be to partition one-half (approximately 2 billion) of the identifiers for the primary application, and to reserve the other half to be allocated as 1,000,000 identifiers for each of up to 2,000 application instances that use database copies.

Each application, whether it is using the primary database or a database copy, is free to create permanent unique identifiers within its allocated block. There is no need for resolution of unique identifiers in the synchronization process, and therefore, there is also no identifier conflict to resolve when one non-primary database users beams not-yet-synchronized data to another.

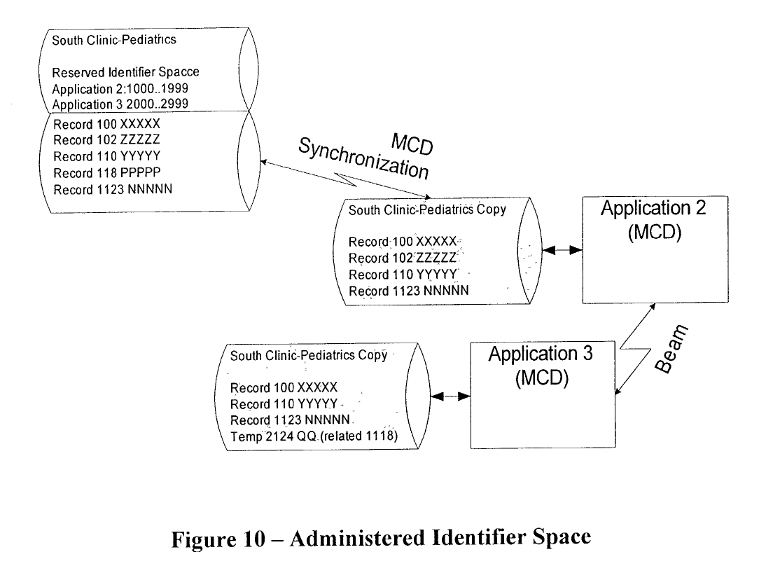

In FIG. 10, identifiers with values less than 1000 are reserved for the “South Clinic-Pediatrics”, values in the range 1000 to 1999 are reserved for Application 1, and values in the range 2000-2999 are reserved for Application 2. New records have been created in both “South Clinic-Pediatrics” and the copy used by Application 2. There is no conflict because with this approach, Application 2 created identifier 1123 (outside the range created in “South Clinic-Pediatrics”). During synchronization, there was no need to resolve any identifier collision and the new record 1123 was created in “South Clinic-Pediatrics”. Prior to synchronization, however, records were beamed from Application 2 to Application 3. Application 3 has created another record, 2124, related to 1118. At this point, all unique identifier still have the values that were originally assigned and there is no need for any modification or tracking of changes to identifiers.

This invention addresses Synchronization Problems (3) and (5) enhancing the synchronization process by creating a copy containing only the MCD's database subset, and using that copy to synchronize with the copy in the MCD. This creates an environment much more consistent with the paradigm supported by MCD concepts.

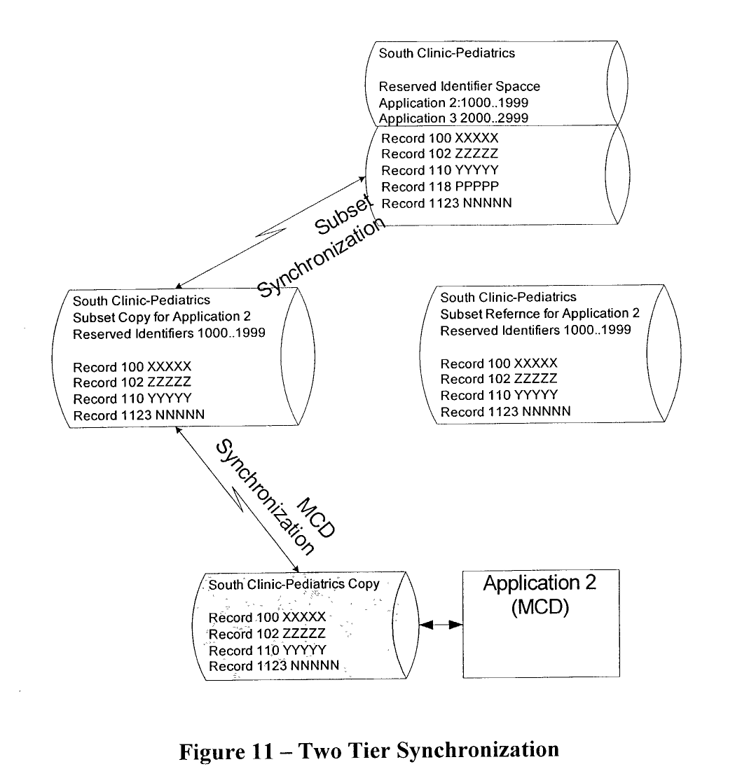

A two tier synchronization process is used in the present invention, as shown in FIG. 11. Synchronization with the MCD maintains consistent content between the MCD database and the stationary copy of the MCD's database subset. Subset synchronization synchronizes changes in the content of the subset with the corresponding records in the full database.

This invention addresses (4) by maintaining a reference copy of the MCD subset when a subset is created for used on the MCD. The reference copy is used in both synchronization steps to determine whether and how both the full database and the subset were modified between the time the subset was created and the time of each synchronization.

The present invention addresses Synchronization Problem (6) by integrating software into each plafform's synchronization services that normalize a view of the database information into a stationary computer's relational database representation.

PALM brand operating system database records are stored in a raw binary (indexed chunk) format. The raw binary format is enhanced by superimposing a multiple field data structure onto the raw data, and treating each chunk as a record set. One of the “fields” in each record contains a globally unique record identifier. This treatment of the information supports interpretation and utilization of the data records as a relational database. Software extensions built into the PALM brand OS Conduit (synchronization software that executes on the stationary computer) transform the information between the native PALM brand OS storage format and a relational database utilized by the stationary computer during the synchronizationb process.

The WINDOWS CE brand database records are transformed into stationary computer databases using data access development tools supported by the WINDOWS CE brand OS manufacturer. The normalized database view is then manipulated using conventional stationary computer database technology.

These transformations result in normalized representations of the information stored on the stationary computer and all of the MCDs in a stationary computer compatible relational database format, so that the stationary computer may use native database operations to operate on all of the data, both independently and as a combined set.

E. Dynamic Usage Focused Adaptation of Databases

The present invention further provides for managing the creation and modification of database record set extensions. Where a primary record set contains pre-defined and static fields that are not intended to be directly accessed by end users, this aspect of the present invention allows for the configuration of record set extensions. This is accomplished by providing a configuration record set and an extension record set in addition to the primary record set. Where the primary record set and the extension record set include a unique identifier field, and the configuration set and the extension record set contain an extension field, extension values corresponding to records in the primary record set may be created and modified without accessing or modifying the primary record set.

For instance, where a primary record set includes a unique identifier field and individuals' personal information—such as name, address, and telephone number—but does not include certain extensions—such as sports played by the individuals—an end user might not be permitted to access the primary record set in order to create an extension such as a sports field in the primary record set. The present invention allows for an end user to manage extensions nonetheless.

The present invention provides for establishing a configuration record set, which includes the various extensions. Further, the configuration record set may include extension options. For instance, if the extension field is SPORTS, the extension options might include: BASEBALL, FOOTBALL, BASKETBALL, SOCCER, and TRACK. The present invention further provides for establishing an extension record set including a unique identifier field—which corresponds to a record in the primary record set—an extension field—which corresponds to a record in the configuration record set—and a value field—which indicates which extension values correspond to records in the primary record set. In this example, there may be a record in the primary record set that includes personal information for William Smith and includes a unique identifier field that has the value 100. Selecting from the configuration table all available extensions for the primary record set will allow an end user to access or modify the extensions available to the William Smith record. Selecting from the extension table those records that include the unique identifier 100 will allow an end user to access or modify the specific extension values for William Smith.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer program embodied on a computer readable medium, when executed by a computer configures the computer to embed data in medical patient records, the computer program comprising:
a code segment for storing to memory and retrieving from memory a plurality of context-centered records corresponding to a plurality of patients, wherein for each of the plurality of patients, the context-centered records comprise a patient record and zero or more visit records, and wherein for each visit record there is at least one encounter record;
a code segment for receiving image data representing a digital image;
a code segment for associating the image data to a first encounter record for a first patient;
a code segment for storing the image data in the memory.

2. The computer program from claim 1, wherein the visit record and the encounter record are combined.

3. The computer program from claim 1, wherein the computer is a personal digital assistant.

4. The computer program from claim 1, further comprising a code segment for sending the image data to a second computer.

5. The computer program from claim 1, further comprising a code segment for synching the plurality of context-centered records with at least one enterprise application.

6. The computer program from claim 1, wherein the plurality of context-centered records as structured for a medical clinic environment.

7. The computer program from claim 1, wherein the plurality of context-centered records are structured for a veterinary clinic environment.

8. A computer program embodied on a computer readable medium, when executed by a computer configures the computer to embed data in database records, the computer program comprising:
a code segment for storing to memory and retrieving from memory a plurality of context-centered records corresponding to a plurality of customers, wherein for each of the plurality of customers, the context-centered records comprise a customer record and at least one encounter record;
a code segment for receiving image data representing a digital image;
a code segment for associating the image data to a first encounter record for a first customer;
a code segment for storing the image data in the memory.

9. The computer program from claim 8, in which the customers are automobile appraisal clients.

10. The computer program from claim 8, in which the customers are real estate clients.

11. The computer program from claim 8, in which the customers are law enforcement personnel.

12. The computer program from claim 8, in which the customers are asset inventory clients.

13. The computer program from claim 8, in which the customers are inanimate physical assets.

14. A computer program embodied on a computer readable medium, when executed by a computer configures the computer to efficiently process a compressed data file, the computer program comprising:
a code segment for determining a record identifier for a record to be retrieved from the compressed data file;
a code segment for retrieving from an array of indices, a starting point associated to the record identifier for the record;
a code segment for determining the record length for the record;
a code segment for extracting a data subset from the compressed data file, the data subset being a function of the starting point and the record length; and
a code segment for decompressing the data subset for obtaining the record in uncompressed form.

15. The computer program from claim 14, wherein the compressed data file stores drug information.

16. The computer program from claim 14, wherein the compressed data file stores patient medical information.

17. The computer program from claim 14, wherein the code segment for retrieving from the array of indices locates the bit within the compressed data file where the record begins.

18. The computer program from claim 14, further comprising:
a code segment for performing a find function on the compressed data file;
wherein the records are ordered by record name;

19. The computer program from claim 18, wherein the find function uses an index-based binary search that includes decompressing the record name for comparison purposes.

20. The computer program from claim 14, wherein the record name is located at the beginning of the record.

21. The computer program from claim 14, further comprising:
a code segment for compressing an uncompressed data file into the compressed data file, wherein the starting point associated with the record in the uncompressed data file is maintained during compression and stored in the array of indices for extracting the data subset from the compressed data file.

22. A computer program embodied on a computer readable medium, when executed by a computer configures the computer to automate medical prescription writing, the computer program comprising:
a code segment for creating a plurality of customized prescription scenarios; and
a code segment for writing a prescription based on one of the customized prescription scenarios.

23. The computer program from claim 22, wherein each of the customized prescription scenarios includes at least one of the following data items: a generic drug name, a trade name for a drug, instructions, dosage, units, route, dosage frequency, number to be dispensed, number of refills, class information.

24. The computer program from claim 23, wherein the code segment for writing a prescription comprises:
a code segment for choosing one of the plurality customized prescription scenarios; and
a code segment for populating the data items from the chosen scenario.

25. A computer program embodied on a computer readable medium, when executed by a computer configures the computer to synchronize a plurality of mobile computing devices with a data repository, the computer program comprising:
a code segment for defining a reserved identifier space a set of unique record identifiers for records in the data repository; and
a code segment for partitioning the reserved identifier space for local administration by the plurality of mobile computing devices, wherein each of the plurality of mobile computing devices is assigned a subset of the reserved identifier space.

26. The computer program from claim 25, wherein the data repository stores medical patient records.

27. A computer program embodied on a computer readable medium, when executed by a computer configures the computer to manage database record sets, the computer program comprising:
a code segment for accessing a primary record set, the primary record set including a set of primary records, each of the primary records including a unique identifier;
a code segment for accessing and modifying a configuration record set, the configuration record set including a set of configuration records, each configuration record including an extension; and
a code segment for accessing and modifying an extension record set, the extension record set including a set of extension records, each extension record including a unique identifier, an extension, and an extension value, such that extension values corresponding to the primary records may be modified by modifying only the set of extension records.
